(19) United States
(12) Patent Application Publication
(10) Pub. No.: US 2014/0353098 A1
(43) Pub. Date: Dec. 4, 2014

(54) SELECTIVELY FIXED DAMPER

(71) Applicant: AVM Industries, Marion, SC (US)

(72) Inventors: Mark Manuel, Conway, SC (US); Jon Roever, Parrish, FL (US)

(21) Appl. No.: 14/461,771

(22) Filed: Aug. 18, 2014

Related U.S. Application Data
(63) Continuation-in-part of application No. 13/046,959, filed on Mar. 14, 2011.
(60) Provisional application No. 61/314,714, filed on Mar. 17, 2010.
(60) Provisional application No. 61/353,364, filed on Jun. 10, 2010.

(51) Int. Cl. F16F 9/56; F16F 13/00

(52) U.S. Cl. CPC F16F 9/56; F16F 13/007
USPC 188/313

(57) ABSTRACT

An example method for operating a lockable damper includes moving a valve assembly together with a piston assembly between a retracted position and an extended position relative to a tube, the moving unassisted by the lockable damper. The method includes communicating a flow of hydraulic fluid through the valve assembly to damp the moving, and restricting the flow of hydraulic fluid through the valve assembly to limit the moving.

### CROSS-REFERENCE TO RELATED APPLICATIONS

The present application is a continuation-in-part application to U.S. patent application Ser. No. 13/046959, which was filed on 14 Mar. 2011 and is incorporated herein by reference. U.S. patent application Ser. No. 13/046959 claims priority to U.S. Provisional Application No. 61/314714, which was filed on 17 Mar. 2010, and to U.S. Provisional Application No. 61/353364, which was filed on 10 Jun. 2010. Both of these provisional applications are incorporated herein by reference.

### BACKGROUND

Lift assists are used to assist movement of one component relative to another component. In one example, the lift assist is used to assist lifting and rotating a vehicle hood relative to the remaining portions of the motor vehicle. The movements of some lift assists are damped. Some dampers provide no lift assistance.

### SUMMARY

A method for operating a lockable damper according to an exemplary aspect of the present disclosure includes, among other things, moving a valve assembly together with a piston assembly between a retracted position and an extended position relative to a tube, the moving unassisted by the lockable damper. The method includes communicating a flow of hydraulic fluid through the valve assembly to damp the moving, and restricting the flow of hydraulic fluid through the valve assembly to limit the moving.

In another example of the foregoing method, the method includes actuating a release mechanism to stop the restricting and permit the moving.

In another example of any of the foregoing methods, the restricting comprises preventing flow of the hydraulic fluid through the valve assembly.

In another example of any of the foregoing methods, during the restricting, the piston assembly is flexible in retraction and rigid in extension.

In another example of any of the foregoing methods, during the restricting, the piston assembly is rigid in extension and flexible in extension.

In another example of any of the foregoing methods, during the restricting, the piston assembly is flexible in retraction and flexible in extension.

In another example of any of the foregoing methods, during the restricting, the piston assembly is rigid in extension and rigid in extension.

In another example of any of the foregoing methods, a first end of the piston assembly is attached to a first vehicle component and an opposing, second end of the piston assembly is attached to a second vehicle component, the piston assembly damping movement of the first vehicle component relative to the second vehicle component during the communicating.

In another example of any of the foregoing methods, the piston assembly is not biased toward the extended position or the retracted position.

A method for operating a lockable damper according to another exemplary aspect of the present disclosure includes moving a piston assembly between a retracted position and an extended position relative to a tube, biasing the piston assembly toward the extended position using, exclusively, at least one mechanical spring, communicating a flow of hydraulic fluid through a valve assembly to damp the moving, and restricting the flow of hydraulic fluid through the valve assembly to limit the moving.

In another example of the foregoing method, the method includes actuating a release mechanism to stop the restricting and reinitiate the moving.

In another example of any the foregoing methods, the restricting comprises preventing flow of the hydraulic fluid through the valve assembly.

In another example of any the foregoing methods, the method includes rotating the piston assembly relative to a non-vertical path during the moving.

A damper according to another exemplary aspect of the present disclosure includes, among other things, a piston assembly moveable between an extended position and a retracted position, and a tube containing a supply of hydraulic fluid. The piston assembly is unbiased toward either the extended position or the retracted position. A valve assembly is disposed within the tube. The valve assembly is coupled in movement together with the piston assembly. A release mechanism is operatively linked to the valve assembly to move a portion of the valve assembly from a first position that restricts a flow of the hydraulic fluid through the valve assembly to a second position that provides a greater flow through the valve assembly.

In another example of the foregoing damper, the first position blocks the flow of the hydraulic fluid through the valve assembly.

In another example of any of the foregoing dampers, the piston assembly is self-centering within the tube.

In another example of any of the foregoing dampers, the damper includes a cavity at an end of the tube opposite the piston assembly to permit the piston assembly to retract when the valve assembly is in the first position.

In another example of any of the foregoing dampers, the release mechanism is biased toward the first position and away from the second position.

In another example of any of the foregoing dampers, the release mechanism assembly is biased toward the second position and away from the first position.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The various features and advantages of the disclosed examples will become apparent to those skilled in the art from the detailed description. The figures that accompany the detailed description can be briefly described as follows.

FIG. 1 shows an example locking lift assist mechanism.

FIG. 2 shows a close-up view of an end of a piston in the FIG. 1 lift assist mechanism.

FIG. 3 shows a close-up view of another end of the piston in the FIG. 1 lift assist mechanism.

FIG. 4 shows a close-up view of a portion of the FIG. 1 lift assist mechanism.

FIG. 5 shows a close-up view of a valve in the FIG. 1 lift assist mechanism.

FIG. 6 shows a hood connected to the FIG. 1 lift assist mechanism.

FIG. 7 shows the FIG. 7 hood in a partially open position.

FIG. 8 shows the FIG. 7 hood in fully open position.

FIG. 9 shows another example lift assist mechanism.

FIG. 10 shows a close-up view of another example valve for use in the FIG. 1 locking lift assist mechanism with the piston in a retracted position.

FIG. 11 shows the valve of FIG. 10 with the piston approaching a fully extended position.

FIG. 12 shows the valve of FIG. 10 with the piston in a fully extended position.

FIG. 13 shows the valve of FIG. 10 with the piston retracting from the fully extended position.

FIG. 14A shows an example damper mechanism in a fully extended position.

FIG. 14B shows the damper mechanism in a less extended position than the FIG. 14A position.

FIG. 14C shows the damper mechanism in a less extended position than the FIG. 14B position.

FIG. 14D shows the damper mechanism in a fully retracted position.

FIG. 15 shows a section view of an example selectively fixed damper.

FIG. 16 shows the damper of FIG. 15 in a retracted position.

FIG. 17 shows the damper of FIG. 15 in an extended position.

FIG. 18 shows a valve mechanism of the damper of FIG. 15 in a first position.

FIG. 19 shows a valve mechanism of the damper of FIG. 15 in a second position.

FIG. 20 shows another example locking damper.

### DETAILED DESCRIPTION

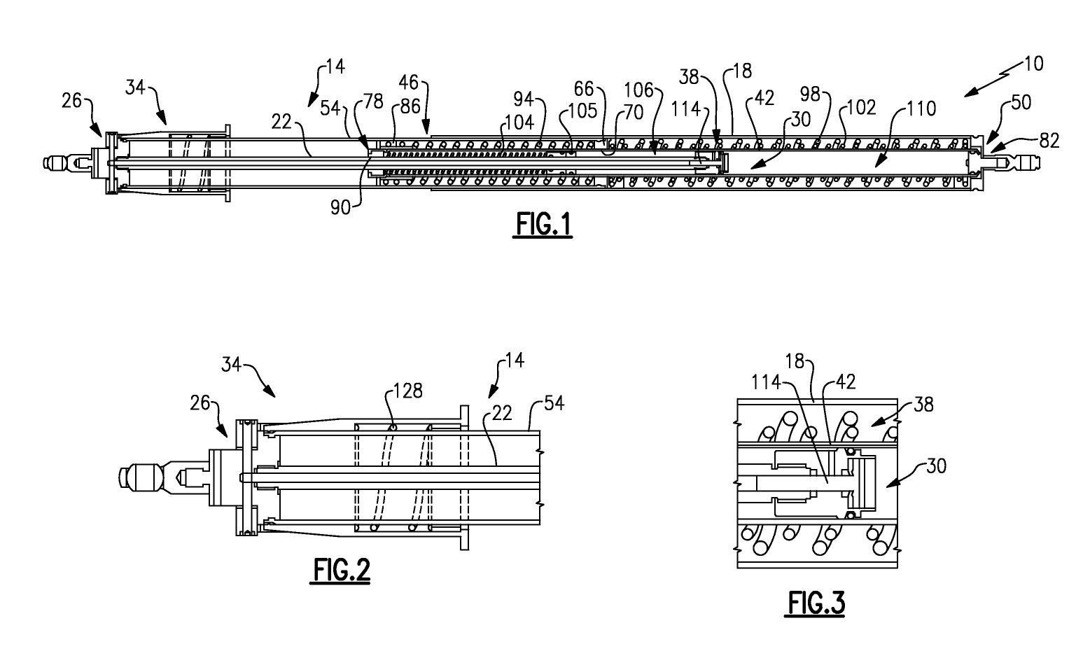

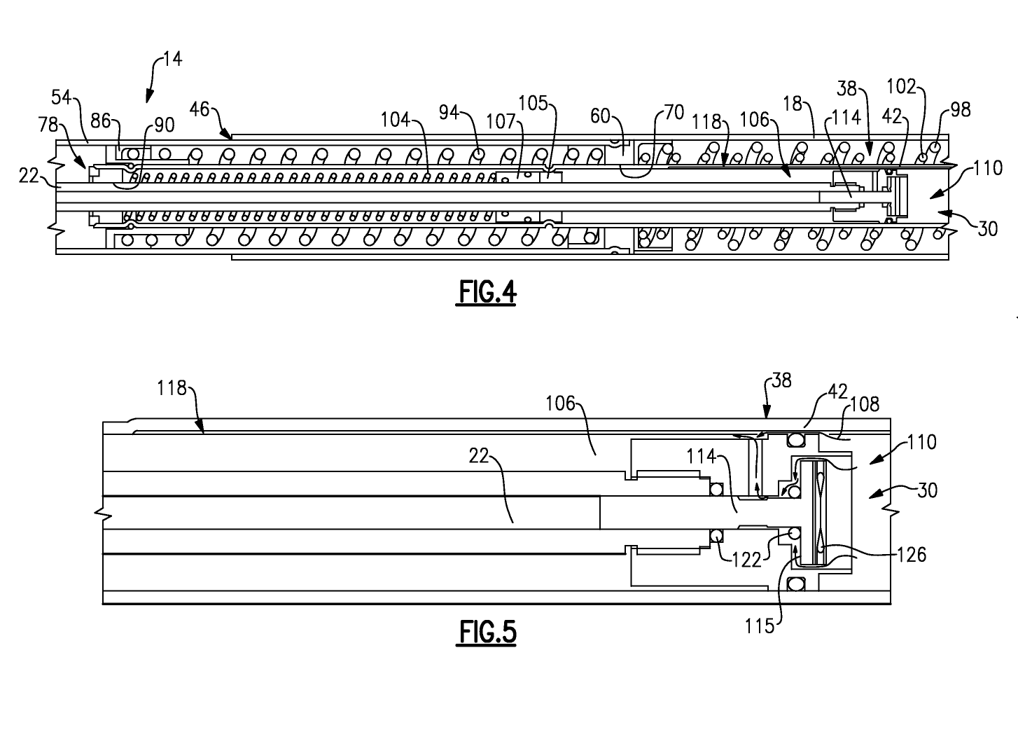

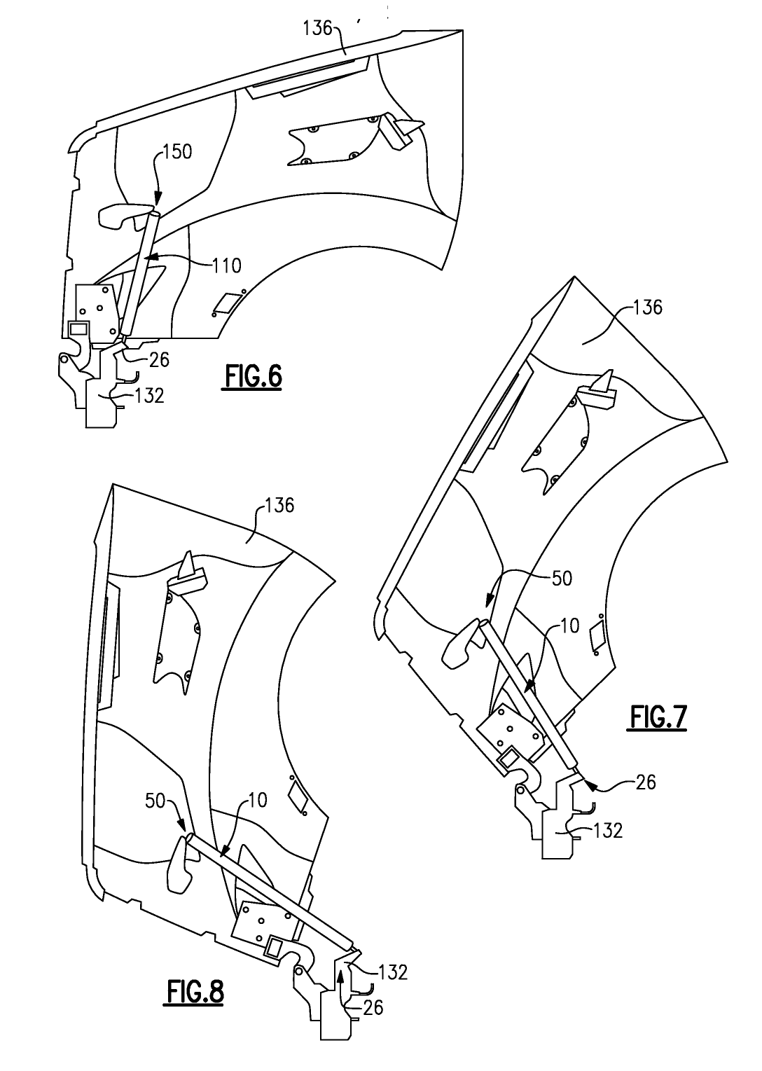

Referring to FIGS. 1-5, an example lift assist mechanism 10 includes a piston assembly 14 received within an outer tube 18. A rod 22 of the piston assembly 14 extends between a first piston end 26 and a second piston end 30. The rod 22 connects to a release mechanism 34 at the first piston end 26. The rod 22 connects to a valve assembly 38 at the second piston end 30. The valve assembly 38 and a portion of the rod 22 are received within an inner tube 42.

The outer tube 18 extends between a first outer tube end 46 and a second outer tube end 50. The first outer tube end 46 is open. The piston assembly 14 is slidably received within the first outer tube end 46. The piston assembly 14 is configured to move between extended positions and retracted positions relative to the outer tube 18 and the inner tube 42.

In this example, the first piston end 26 is secured to a vehicle body (not shown), and the second outer tube end 50 of the outer tube 18 is secured to a moveable vehicle component, such as a vehicle hood (not shown). As the movable vehicle component is moved relative to the stationery vehicle component, the piston assembly 14 moves relative to the outer tube 18. A person skilled in the art and having the benefit of this disclosure would understand how to suitably secure the first piston end 26 and the second outer tube end 50.

The piston assembly 14 includes a piston tube 54 that extends from the release mechanism 34 at the first piston end 26 to terminate at a ring 66 housed within the outer tube 18. The ring 66 establishes an aperture 70 that slidably receives the inner tube 42. The ring 66 slides over the inner tube 42 as the piston assembly 14 moves between extended positions and retracted positions, which stabilizes movements of the piston assembly 14 and the inner tube 42.

The inner tube 42 extends between a first inner tube end 78 and a second inner tube end 82. The second inner tube end 82 is secured adjacent the second outer tube end 50. The first inner tube end 78 extends axially past the first outer tube end 46 and terminates within the piston tube 54 at a stop member assembly 86. The stop member extends radially between the rod 22 and an inner wall of the piston assembly 14.

In this example, the stop member assembly 86 establishes an aperture 90 that slidably receives the rod 22. The rod 22 slides within the aperture 90 relative to the stop member assembly 86 as the piston assembly 14 is extended and retracted. The stop member assembly 86 facilitates maintaining the radial positioning of the rod 22 during movement of the piston assembly 14.

A first spring 94 is housed within the piston assembly 14 and extends between the ring 66 and the stop member assembly 86. The rod 22 and the inner tube 42 are radially inboard the first spring 94 in this example.

The example lift assist mechanism 10 also includes a second spring 98 and a third spring 102 that extend from the ring 66 to the second outer tube end 50 and second inner tube end 82. The inner tube 42 and the rod 22 are radially inboard the second spring 98 and the third spring 102.

The second spring 98 and the third spring 102 are biased to urge the piston assembly 14 toward an extended position. The first spring 94 is biased to urge the piston toward a retracted position. The second spring 98 and the third spring 102 thus provide lift assisting forces to the lift assist mechanism 10.

As can be appreciated, the first spring 94 also damps the force exerted by the second spring 98 and the third spring 102. Similarly, the second spring 98 and the third spring 102 damp the forces exerted by the first spring 94. The first spring 94, the second spring 98, and the third spring 102 thus damp and assist movement of the piston assembly 14 relative to the outer tube 18.

In this example, hydraulic fluid is used to damp movement of the piston assembly 14 relative to the outer tube 18. The hydraulic fluid moves through and around the valve assembly 38 between a cavity 106 and a cavity 110 as the piston assembly 14 moves relative to the outer tube 18. Forcing the valve assembly 38 to move through hydraulic fluid in the inner tube 42 slows movement of the rod 22 and the remaining portions of the piston assembly 14. The hydraulic fluid moves through the valve assembly 38 between the cavity 106 and the cavity 110.

The example lift assist mechanism 10 further includes a fourth spring 104 within the inner tube 42. The fourth spring 104 extends from the stop member assembly 86 to a stop member 105 disposed within the inner tube 42 between the stop member assembly 86 and the valve assembly 38. The fourth spring 104 biases a slider 107 toward the stop member 105. The slider 107 accommodates hydraulic fluid flowing into the cavity 106. The slider 107 essentially adjusts the volume of the cavity 106 to accommodate hydraulic fluid and provides a non-cavitating functionality to the lift assist mechanism 10.

In this example, a valve pin portion 114 of the rod 22 moves axially relative to the remaining portions of the valve assembly 38 to restrict or permit flow between the cavity 110 and the cavity 106. FIG. 5 shows the general fluid communication path of the hydraulic fluid from the cavity 106 to the cavity 110 when the valve pin portion 114 is in an open position. A surface 115 of the valve pin portion 114 presses against a ring seal 122 to block flow through the valve assembly 38 when the valve pin portion 114 moves away from the open position.

Varying the relative size of the ring seal 122 can adjust the sealing characteristics. In this example, the ring seal 122 is spaced slightly from the valve pin portion 114 or the other portions of the valve assembly 38 to allow flow through the valve assembly 38 when the surface 115 is spaced from the ring seal 122.

In this example, the inner tube 42 establishes a groove 118 that permits a bypass flow of the hydraulic fluid from the cavity 106 to the cavity 110 around the valve assembly 38 at 108. When the valve assembly 38 is axially aligned with the groove 118, the valve assembly 38 is not able to prevent all flow of hydraulic fluid between the cavity 106 and the cavity 110 because, when axially aligned with the groove 118, hydraulic fluid is able to move around the valve assembly 38 through the groove 118 between the cavity 106 and the cavity 110.

When the valve assembly 38 is axially misaligned with the groove 118, the valve assembly 38 is able to block flow of hydraulic fluid between the cavity 106 and the cavity 110. As can be appreciated, blocking flow between the cavity 106 and the cavity 110 locks the position of the piston assembly 14 relative to the outer tube 18.

In this example, the piston assembly 14 is axially misaligned with the groove 118 when the piston assembly 14 is nearly fully extended. Thus, the valve assembly 38 is able to prevent flow between the cavity 106 and the cavity 110 only when the piston assembly 14 is nearly fully extended. Accordingly, the piston assembly 14 can be partially extended and retracted without locking. Other examples include other types of grooves 118 and features enabling locking the piston assembly 14 in other positions.

In this example, the seal rings or pin seals 122 help control flow of fluid through the valve assembly 38. The valve pin portion 114 moves axially relative to the remaining portions of the valve assembly 38 to permit or restrict flow of hydraulic fluid between the cavity 106 and the cavity 110 through the valve assembly 38.

A fifth spring 126 is used to urge the valve pin portion 114 to a restricted flow position. Flow of hydraulic fluid between the cavity 106 and the cavity 110 overcomes the force of the fifth spring 126 and maintains the valve pin portion 114 in an open position. Eventually, the fluid pressure between the cavity 106 and the cavity 110 equalizes, and the fifth spring 126 is able to move the valve pin portion 114 to the closed position.

As the piston assembly 14 is retracted, the valve pin portion 114 can be in a locked position and hydraulic fluid, such as oil, can bypass the valve assembly 38 through the groove 118. Alternatively, as the piston assembly 14 is retracted, the valve pin portion 114 can be held in an unlocked or open position, and the hydraulic fluid moves through the valve assembly 38 and the groove 118. As the piston assembly 118 is extended, the hydraulic fluid is moves through the groove 118 and depresses the fifth spring 126.

In this example, actuating the release mechanism 34 overcomes the biasing force of the fifth spring 126 with the valve pin portion 114 to facilitate flow of hydraulic fluid between the cavity 106 and the cavity 110. For example, the operator can urge the release mechanism 34 axially toward the outer tube 18, which moves the rod 22 forces the valve pin portion 114 to a position that permits flow through the valve assembly 38.

Adjustments to the openings within the valve assembly 38, the groove 118 in the inner tube 42, or both, may take place to modify flow between the cavity 106 and the cavity 110, and the associated damping due to the hydraulic fluid movement. Restricting the flow through the valve assembly 38 increases the damping, for example.

The example release mechanism 34 includes a sixth spring 128 configured to bias the release mechanism 34 toward a position corresponding to the valve assembly 38 in a restricted flow position, which locks the lift assist mechanism 10. The biasing force of the sixth spring 128 accommodates manufacturing variability in the lift assist mechanism 10 and the associated mounting locations. The manufacturing variability is +/−0.5 inches in some examples.

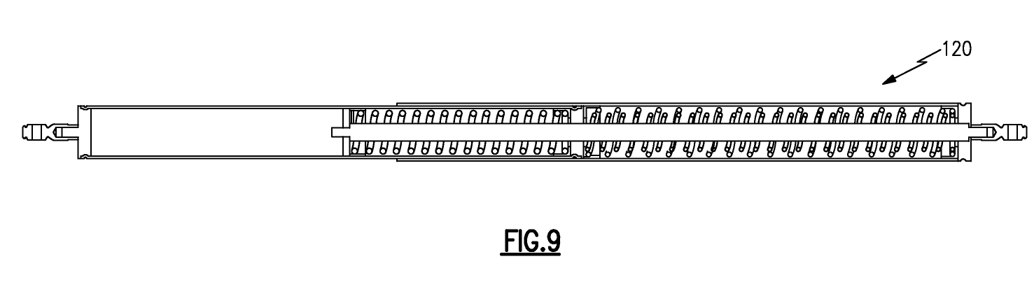

Referring to FIGS. 6-8, the first piston end 26 is secured adjacent a vehicle body mounting location 132, and the second outer tube end 50 is secured to a vehicle hood 136. In FIG. 6 the hood 136 is in a closed position and the piston assembly 14 of the lift assist mechanism 10 is retracted relative to the outer tube 18. In this position, the valve assembly 38 is axially aligned with at least a portion of the groove 118.

In this example, the second spring 98 and the third spring 102 provide lift support of the hood 136 from a closed position to a balance point in the rotation of the hood 136. The first spring 94 damps acceleration of the hood 136 as is moves past the balance point and provides lift support to move the hood 136 from a fully open position to the balance point in the rotation of the hood 136.

FIG. 7 shows the hood 136 in a partially open position at the balance point of the hood 136. The valve assembly 38 is partially aligned with the groove 118 in this position.

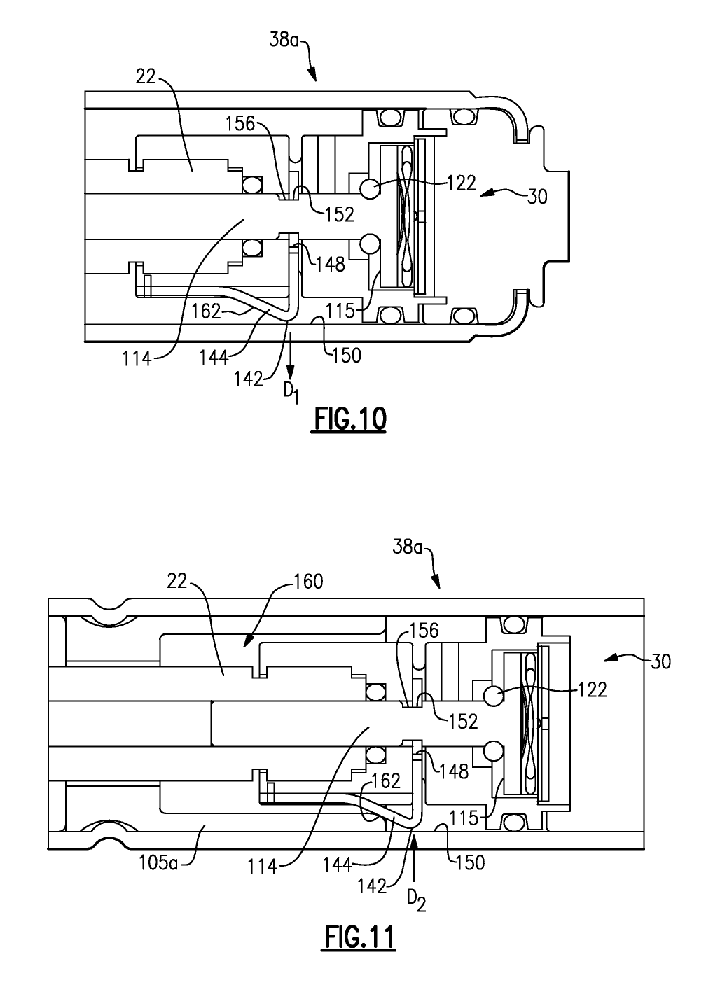

FIG. 8 shows the hood 136 in a fully opened position. In this position, the piston assembly 14 is fully extended and the valve assembly 38 is axially misaligned with the groove 118. In this position, the valve assembly 38 is able to block flow of hydraulic fluid between the cavity 106 and the cavity 110 to lock the position of the lift assist mechanism 10. The release mechanism 34 is thus only needed when the hood is fully opened.

As can be appreciated, the lift assist mechanism 10 extends along a non-vertical path during the extending.

Referring to the example embodiment of FIG. 9, an example lift assist mechanism 120 does not include the release mechanism 34 or the valve assembly 38 (FIG. 1). The lift assist mechanism 140 facilitates damping the hood of FIGS. 7-9, but does not provide locking functionality.

In one example, the lift assist mechanism 140 is mounted to the hood 136 opposite the lift assist mechanism 10. The lift assist mechanism 140 is mounted to the passenger side of a vehicle in this example. The lift assist mechanism 140 assists lifting the hood 136 together with the lift assist mechanism 10.

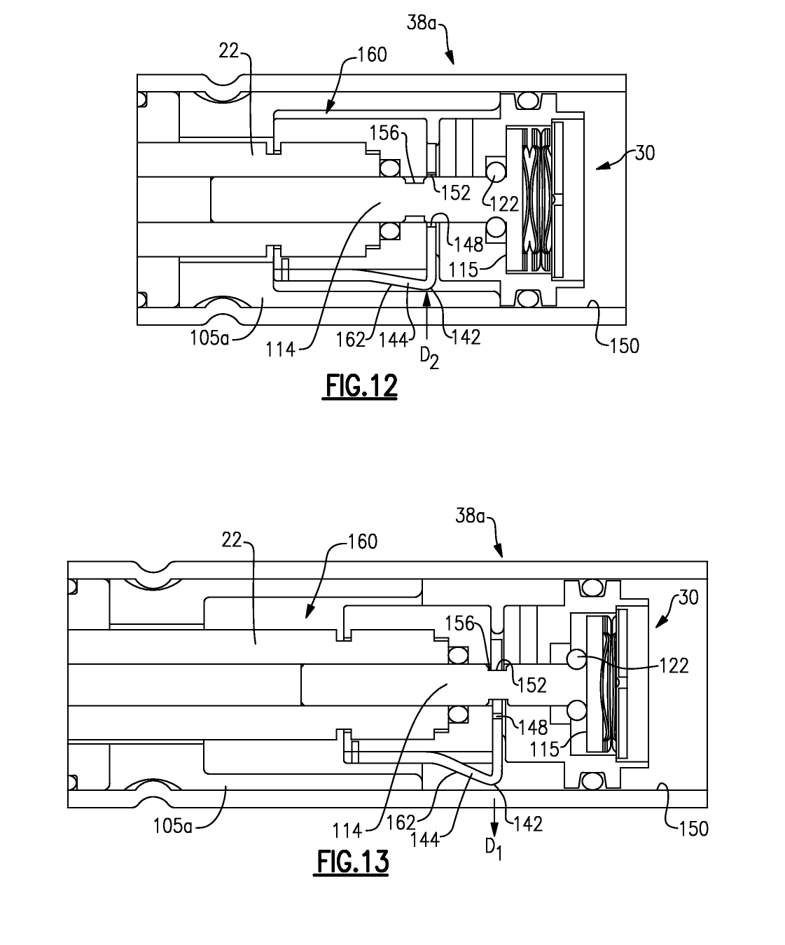

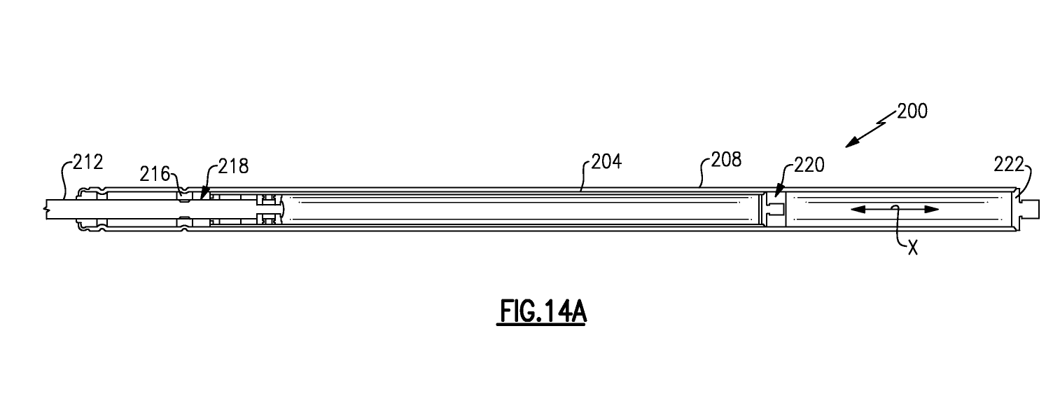

Referring to FIGS. 10-13, in another example, a valve assembly 38a is mountable adjacent the second piston end 30. The valve assembly 38a utilizes a spring clip 144 to control locking of the valve assembly 38a. Notably, examples using the valve assembly 38a do not require the groove 118 (FIG. 5).

In this example, the spring clip 144 establishes an aperture 148 that receives the rod 22, and specifically the valve pin portion 114 of the rod 22. The example spring clip 144 is biased in a direction D₁ toward a radially outer position relative to the rod 22.

During some of the piston assembly 14 travel relative to the outer tube 18 and inner tube 42, a radially outer portion 142 of the spring clip 144 moves radially near, or even contacts, an inner wall 150 of the outer tube 18. An edge 152 of the spring clip 144 engages a notch 156 established in the valve pin portion 114 of the rod 22 when the radially outer portion 142 of the spring clip 144 contacts the inner wall 150.

The spring clip 144 limits axial movement of the rod 22 when the edge 152 of the spring clip 144 engages the notch 156. As can be appreciated, limiting axial movement of the rod 22 prevents the valve pin portion 114 of the rod 22 (and particularly the surface 115 of the valve pin portion 114) from compressing the ring seal 122, which would block flow through the valve assembly 38a.

Notably, the piston assembly 14 is free to move between extended positions and retracted positions relative to the outer tube 18 and the inner tube 42 when the hydraulic fluid is able to move through the valve assembly 38a. In this example, the hydraulic fluid is able to move through the valve assembly 38a when the valve assembly 38a is in the positions of FIGS. 10, 11, and 13.

In this example, the radially outer portion 142 of the spring clip 144 contacts the inner wall 150 except when the piston assembly 14 is at or near a fully extended position relative to the outer tube 18 and the inner tube 42. Accordingly, the piston assembly 14 is free to move between extended positions and retracted positions relative to the outer tube 18 and the inner tube 42 except when the piston assembly 14 is at or near a fully extended position relative to the outer tube 18 and the inner tube 42. If a user decides to stop extension or retraction of the piston assembly 14 when the spring clip 144 is engaged with the notch 156, the spring clip 144 will keep the valve pin portion 22 open and in an unlocked position allowing hydraulic fluid to flow through the valve assembly 38a.

As the piston assembly 14 approaches a fully extended position, a portion of the valve assembly 38a is received within a recessed area 160 of a stop member 105a. The recessed area 160 has a narrower diameter than the outer tube 18. As the portion of the valve assembly 38a moves into the recessed area 160, a ramped area 162 of the spring clip 144 contacts the stop member 105a such that portions of the spring clip 144 are forced radially inward in a direction D₂ until the spring clip 144 disengages the notch 156 and the rod 22 is free to move axially relative to the spring clip 144.

In one example, the fifth spring 126, a wave spring, presses the surface 115 of against the o-ring 122 when the spring clip 144 disengages the notch 156, which blocks movement of hydraulic fluid through the valve assembly 38a. The piston assembly 14 is not free to move between extended positions and retracted positions relative to the outer tube 18 and the inner tube 42 when the hydraulic fluid is blocked from moving through the valve assembly 38a. Thus, the position of the piston assembly 14 is locked when the spring clip 144 disengages the notch 156.

In this example, once the piston assembly 14 is locked, actuating the release mechanism 34 is necessary to overcome the biasing force of the fifth spring 126 to reestablish flow of hydraulic fluid through the valve assembly. In one example, the operator urges the release mechanism 34 axially toward the outer tube 18 to unlock the piston assembly 14. Urging the release mechanism 34 moves the rod 22 and forces the valve pin portion 114 to a position that reestablishes flow through the valve assembly 38. The operator holds the release mechanism 34 until the radially outer edge 142 of the spring clip 144 contacts the inner wall 150 of the outer tube 18. The edge 152 of the spring clip 144 then engages the notch 156 to lock the valve pin portion 114 in a position that allows flow through the valve assembly 38.

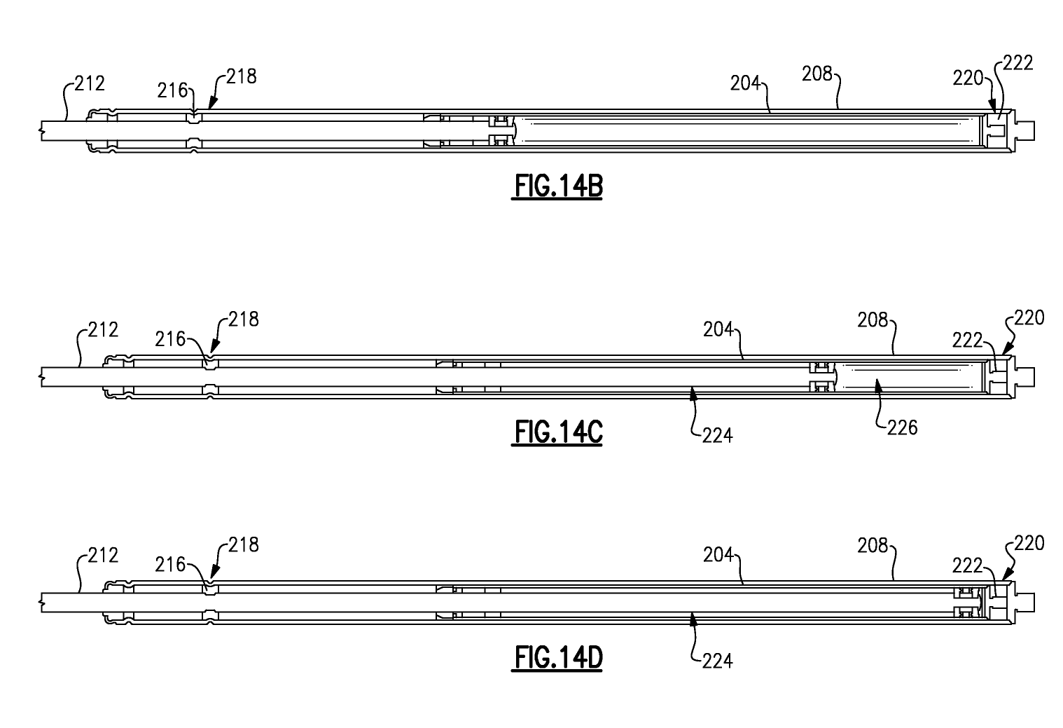

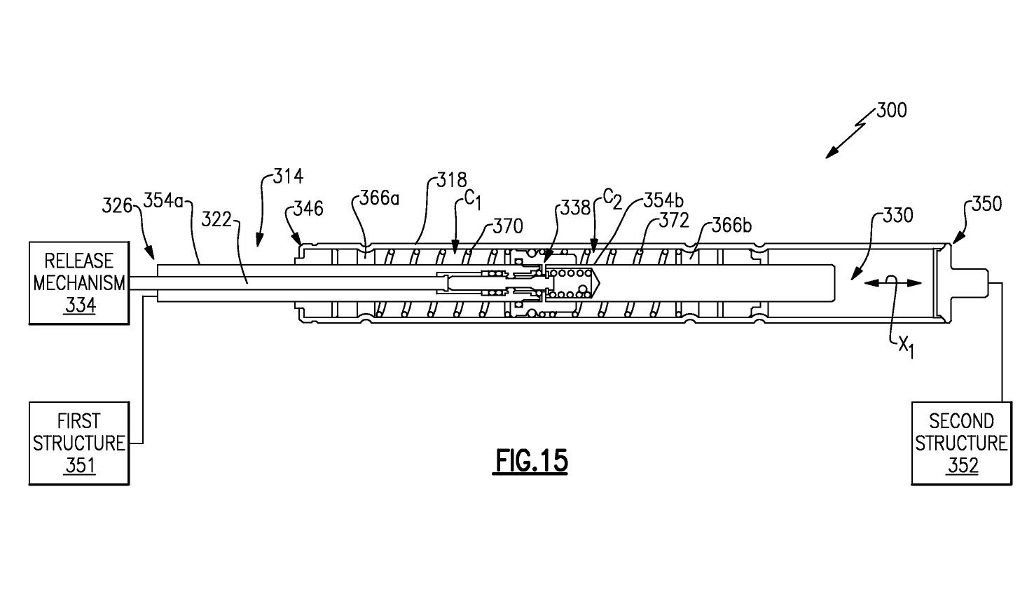

Referring to FIGS. 14A-14D, an example damper mechanism 200 includes a damper tube 204 received within an outer tube 208. The damper tube 204 is slideable relative to the outer tube 208 along an axis X. A piston assembly 212 is configured to move between extended positions and retracted positions relative to the outer tube 208.

In this example, the outer tube 208 is attachable to a vehicle body, and the piston assembly 212 is attachable to a vehicle component, such as a vehicle hood. In one example, the damper mechanism 200 is used on the passenger side of the vehicle hood 136 (FIG. 6-8), and the lift assist mechanism 10 is used on the driver side of the vehicle hood 136.

The piston assembly 212 moves to an extended position when the component is opened relative to the vehicle body, for example. In the fully extended position, and end 218 the damper tube 204 is positioned against a stop 216. In the fully retracted position, an end 220 of the damper tube 204 the damper tube 204 is positioned against a stop 220.

In this example, the damper tube 204 is full of a fluid, such as a hydraulic oil. As can be appreciated, the fluid damps movement of the piston assembly 212 as the piston assembly 212 moves relative to the damper tube 204. The resistance that the fluid exerts against the piston assembly 212 is greater than the resistance that the damper tube 204 must overcome to move relative to the outer tube 208. Accordingly, when the piston assembly 212 is moved between the fully extended position and the fully retracted position, the damper tube 204 moves relative to the outer tube 208 before the piston assembly 212 moves within the damper tube 204. That is, as the piston assembly 212 moves from the fully extended position in FIG. 14A to the retracted position of FIG. 14C, and the fully retracted position of FIG. 14D, the damper tube 204 first slides relative to the outer tube 208. The piston assembly 212 then moves relative to the outer tube 208.

When moving from the fully extended position, the damper tube 204 slides within the outer tube 208 until an end 220 of the damper tube 204 contacts the end cap 222 of the outer tube 208. This movement is not significantly damped. Once the damper tube 204 contacts the end cap 222, the piston assembly 212 begins to move relative to the damper tube 204. In this example, the piston assembly 212 moves through oil when moving relative to the damper tube 204. The piston assembly 212 movement through oil is damped more than movement of the damper tube 204 relative to the outer tube 208.

As movement is initiated from the fully retracted position of FIG. 14D, the piston assembly 212 moves the damping tube 204 relative to the outer tube 208 before the piston assembly 212 begins to move through the oil in the damping tube 204. Again, the resistance of the piston assembly 212 moving through the oil and the damper tube 204 is greater than the resistance of the damping tube 204 against the outer tube 208. This facilitates initiating movement of the damping tube 204 relative to the outer tube 208 before the piston assembly 212 begins to move through the oil in the damping tube 204.

The damping tube 204 moves relative to the outer tube 208 until the damping tube 204 contacts the stop 216. At this point, the resistance of the damping tube 204 moving relative to the outer tube 208 is greater than the resistance of the piston assembly 212 moving through the oil in the damping tube 204. The piston assembly 212 moves through the oil in the damper tube 204 after the damper tube 204 contacts the stop 216.

The initial movements of the piston assembly 212 when moving from a fully extended position or a fully retracted position correspond to the damping tube 204 moving relative to the outer tube 208. Accordingly, relatively low efforts are required to initiate movement of the piston assembly 212 from the fully extended position or the fully retracted position. The relatively low efforts facilitate an operator opening or closing a vehicle hood, for example.

In one example, areas 224 and 226 each include a compression spring (not shown). The compression springs position the portion of the piston assembly 212 within the damping tube 204. The spring controls the location at which the piston assembly 212 begins to move through oil in the damping tube 204. In one example, an operator starts to open or close the hood, but then moves the hood in the opposite direction mid-stroke. Positioning the portion of the piston assembly 212 within the damping tube 204 using springs helps damp this movement.

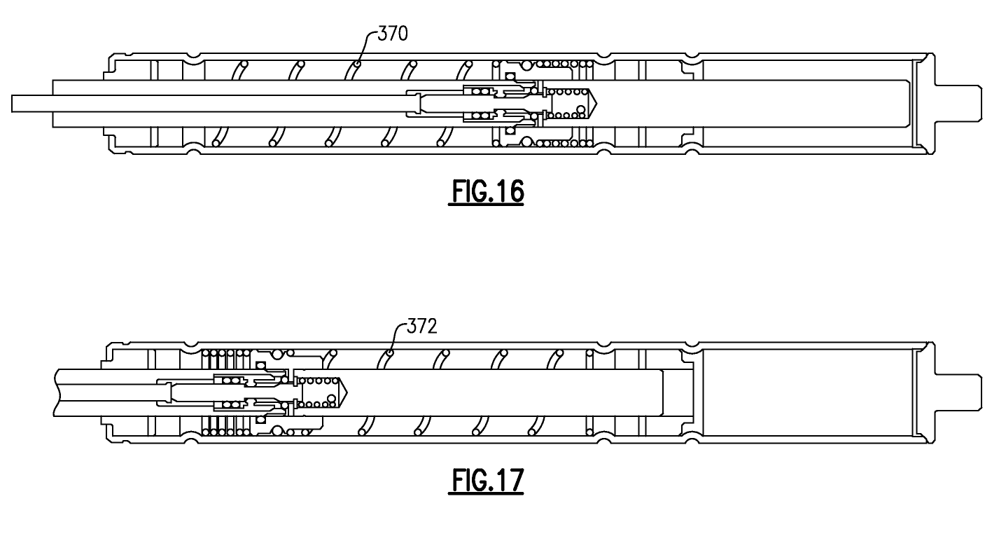

Referring now to FIGS. 15 to 17, an example lockable damper 300 includes a piston assembly 314 received within an outer tube 318. The piston assembly 314 extends from a first piston end 326 to a second piston end 330. The piston assembly includes a rod 322 and a valve assembly 338. The rod 322 connects to a release mechanism 334 at the first piston end 326. An opposing end of the rod 322 connects to the valve assembly 338.

The outer tube 318 extends between a first outer tube end 346 and a second outer tube end 350. The piston assembly 314 is slidably received within the first outer tube end 346. When the damper 300 is unlocked, the piston assembly 314 is configured to move between extended positions and retracted positions relative to the outer tube 318 along an axis X₁.

In this example, the first piston end 326 is secured to a first structure 351, and the second outer tube end 350 of the outer tube 318 is secured to a second structure 352. The first piston end 326 and the second outer tube end 350 can be pivotably secured to the first and second structures 351 and 352.

Notably, the damper 300 does not include pressurized fluid, mechanical springs, or any other biasing device for assisting in moving the piston assembly 314 relative to the outer tube 318 when connected to the first structure 351 and the second structure 352. The example damper 300 provide no, or nominal, lifting assist and is thus not a lift assisting damper.

In one example, the first structure 352 is a seat for a heavy-duty truck, and the second structure is a seat support. In other examples, the first piston end 326 and the second tube end 350 can connect to other structures, such as connecting a cruise control lever to a vehicle support. In still other examples, the first piston end 326 and the second tube end 350 can connect structures, such as an accelerator pedal or steering control.

The damper 300 can be unlocked to permit damped movement of the first structure relative to the second structure. The piston assembly 314 extends and retracts relative to the outer tube 318 during this damped movement. Notably, the first structure 351 and the second structure 352 move relative to each other to extend and retract the piston assembly 314 relative to the outer tube 318. That is, the damper 300 does not substantially assist the movement of the first structure 351 relative to the second structure 352.

The damper 300 can be locked to restrict damped movement of the first structure to the second structure. The valve assembly 338 is actuated by axial movements of the rod 322. The release mechanism 334 moves the rod 322 to control movement between the unlocked and locked positions. The release mechanism 334 is similar the release mechanism 34 (FIG. 1) in some examples.

In addition to the rod 322, the piston assembly 314 includes a piston tube 354 having a first portion 354a and a second portion 354b. The valve assembly 338 is coupled to both the first portion 354a to the second portion 354b and is positioned axially between the first portion 354a and the second portion 354b. The rod 322 is received within the first portion 354a and is moveable relative to the first portion 354a to actuate the valve assembly 338.

Annular support rings 366a and 366b establishe apertures that slidably receive the tube 354. The rings 366a and 366b stabilize the tube 354 as the tube 354 extends and retracts relative to the outer tube 318 along the axis X₁.

A first spring 370 is housed within a first cavity C₁ of the piston assembly 314. The first spring 370 extends between the ring 366a and the valve assembly 338. The rod 322 and the tube 354 are radially inboard the first spring 370 in this example.

A second spring 372 is housed within a second cavity C₂ of the piston assembly 314. The second spring 372 extends between the ring 366b and the valve assembly 338. The rod 322 and the tube 354 are radially inboard the first spring 370 in this example.

The first spring 370 and the second spring 372 bias the valve 338 in opposite directions to position the valve assembly 338, and thus the piston assembly 314 relative to the outer tube 318. In this example, the first spring 370 and the second spring 372 bias the piston assembly 338 in a mid-travel position where the piston assembly 314 is midway between a fully extended position and a fully retracted position. The example damper 300 is thus considered a “self-centering” damper. The first spring 370 and the second spring 372 could be designed to bias the piston assembly 338 to other positions.

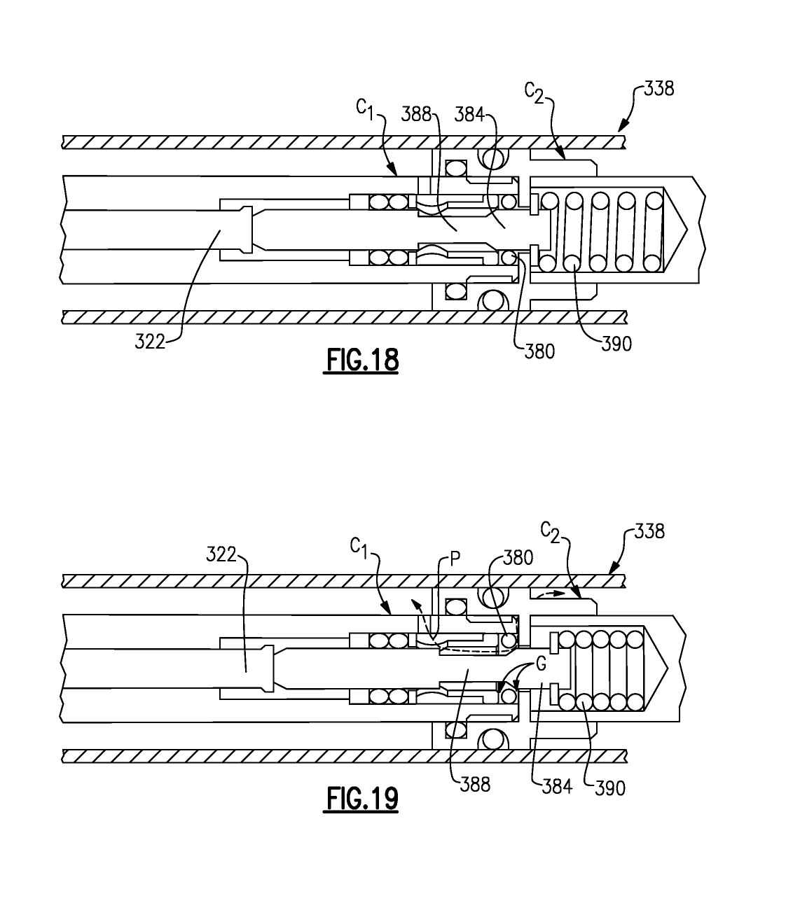

Notably, the first spring 370 and the second spring 372 do not provide force sufficient to provide lifting assistance or to otherwise aid in moving the first structure 351 relative to the second structure 352. That is the first spring 370 is not substantially pushing against the valve assembly 338 when the locking damper 300 is fully retracted (FIG. 16), and the second spring 372 is not substantially pushing against valve assembly 338 when the locking damper 300 is fully extended (FIG. 17).

The first cavity C₁ and the second cavity C₂ include a hydraulic fluid. The valve assembly 338 controls flow of fluid between the first cavity C₁ and the second cavity C₂. Blocking all flow through the valve assembly 338 effectively locks the position of the piston assembly 314 relative to the outer tube 318. Blocking some flow through the valve assembly 338 varies the damping of the piston assembly 314 moving relative to the outer tube 318.

The valve assembly 338 can be moved by the rod 322 back and forth between the first position of FIG. 18 and a second position of FIG. 19. In the first position, the valve assembly 338 restricts a flow of the hydraulic fluid through the valve assembly 338. In the second position, the valve assembly 338 permits a greater flow through the valve assembly 338 than when the valve assembly 338 in the first position.

In the valve assembly 338, a ring seal 380 is aligned with a thicker diameter portion 384 of the rod 322 when in the first position, and the ring seal 380 is aligned with a thinner diameter portion 388 of the rod 322 when in the second position.

In this example, the valve assembly 338 in the first position restricts all flow between the first cavity C₁ and the second cavity C₂. In other examples, the valve assembly 338 in the first position 338 restricts some flow to permit some damped movement of the piston assembly 314 relative to the outer tube 318.

The thicker diameter portion 384 of the rod 322 presses against the ring seal 380 to restrict the flow. When all flow through the valve assembly 338 is restricted, the position of the valve assembly 338 within the tube 354 is locked, which prevents the tube 354 from extending and retracting relative to the outer tube 318.

The valve assembly 338 in the second position permits flow between the first cavity C₁ and the second cavity C₂ along a path P. Aligning the ring seal 380 with the thinner diameter portion 388 of the rod 322 results in gaps G around the ring seal 380. The seal 380 prevents flow through the gaps when compressed by the thicker diameter portion 384 of the rod 322. Flow moves through these gaps G between the first cavity C₁ and the second cavity C₂. Flow through valve assembly 338 permits damped movement of the piston assembly 314 between extended positions and retracted positions relative to the outer tube 318.

To move the rod 322, the release mechanism 334 is actuated. The release mechanism 334 could have any form appropriate for moving the rod 322. In one example, depressing the release mechanism 334 depresses the rod 322 to move the valve assembly 338 from the first position to the second position and permit allows fluid to flow between the first cavity C₁ and the second cavity C₂. When the release mechanism is released, a spring 390 returns the valve assembly 338 to the first position.

In another example, depressing the release mechanism 334 to depress the rod 322 moves the valve assembly 338 from the second position to the first position, and releasing the release mechanism 334 permits the valve assembly 338 to move back to the second position from the first position.

In this example, the valve assembly 338 can move between the first position and the second position when the piston assembly 314 is in the mid-travel position of FIG. 15, the extended position of FIG. 16, or the retracted position of FIG. 17. The damper 300 can thus be locked in any position between fully retracted position of FIG. 16 and the fully extended position of FIG. 17.

When the example valve assembly 338 is locked and the damper 300 is in the first position, the piston assembly 314 is not able to extend and retracts relative to the outer tube 318.

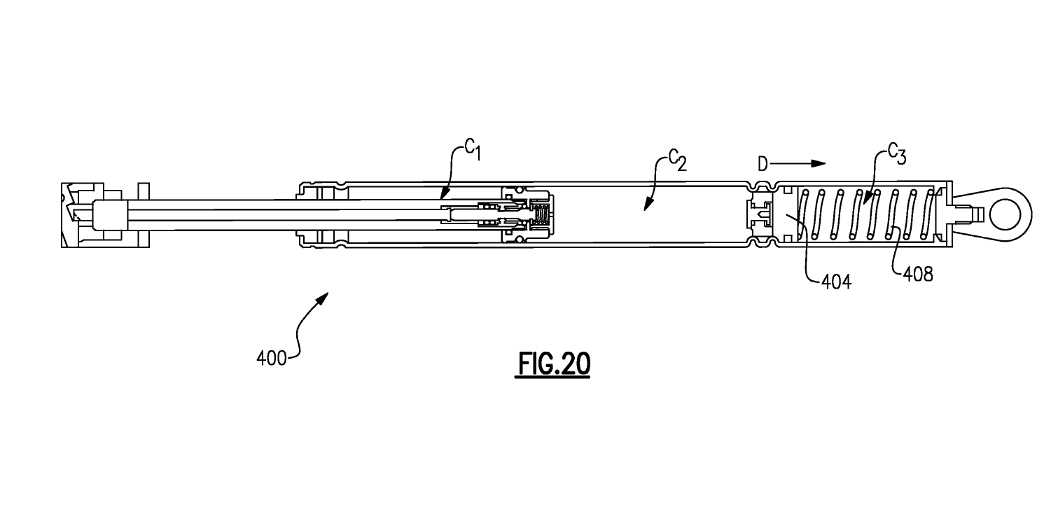

In the damper 400 of the example embodiment of FIG. 20, the valve assembly 338 moves between the first position and the second position to selectively prevent flow between the cavity C₁ and C₂. In the damper 400, the cavities C₁ and C₂ do not include springs to position the valve assembly 338. The damper 400 is thus not self-centering when the valve assembly is in the second position. In another example, the damper 400 includes the springs 370 and 372 and is self-centering.

The damper 400 includes a cavity C₃, which permits some movement of the valve assembly 338 when the piston assembly 314 is retracted, even if the damper 400 is in the first position.

When the piston assembly 314 of the damper 400 retracts, some the fluid in the cavity C₂ moves toward the cavity against a stop 404. After sufficient force is applied, the fluid in the cavity C₂ overcomes a biasing force of a spring 408 within the cavity C₃. The spring 408 biases the stop 404 toward the cavity in a direction D. Retracting the piston assembly 314 and moving the fluid of the cavity C2 against the stop 404 overcomes the biasing force and displaces the stop 404 to permit the piston assembly 314 to retract even though fluid is not moving from cavity C2 to cavity C3. The damper 400 is thus flexible when retracting and rigid when extending if the valve assembly 338 is locked. The biasing force of the spring 408 can be adjusted to influence how much retraction is permitted when the valve assembly 338 is locked.

In other example locking dampers, an additional cavity could be placed opposite the cavity C₁ to permit the damper to be flexible when extending. These other example locking dampers could be rigid when compressing and flexible when extending if the valve assembly 338 is in the first position. If the additional cavity and the cavity C₃ are both used, the other example locking dampers could be flexible when compressing and flexible when extending if the valve assembly 338 is in the first position. Any of these other example dampers could be self-centering if springs 370 and 372 are including in the cavities C₁ and C₂.

Features of some of the disclosed examples include hydraulic dampening throughout travel of a piston assembly relative to a cylinder, and a hydraulic locking mechanism that works in certain positions of a piston relative to a cylinder. Another feature includes resetting the locking mechanism when the piston assembly is certain positions relative to the tube, such as a fully extended position. Yet another feature includes a locking collar assembly that can accommodate up to one inch of variation in length and a spring within the valve that can mechanically return the pin of the valve assembly to a position that blocks flow between the cavities. A feature of the example incorporating the valve assembly 38a includes providing a lockable piston assembly without requiring a groove or other similar features in the outer tube.

Features of the disclosed examples include controlling bouncing and rate-of-motion of a lift assist mechanism. Another feature includes smoothing operation of the lift assist mechanism in both directions of motion using oil (hydraulic) damping. Yet another feature includes a lift assist mechanism that is lockable in a particular position.

Features of the embodiment disclosed in FIGS. 14 and 15 include damping movement at the end of piston travel without increasing the force to initiate movement to an extended position or initiate movement to a retracted position. Essentially, the example damper mechanism 200 does not significantly increase the force to open and close a component relative to another damped component.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

I claim:

1. A method for operating a lockable damper, comprising:
moving a valve assembly together with a piston assembly between a retracted position and an extended position relative to a tube, the moving unassisted by the lockable damper;
communicating a flow of hydraulic fluid through the valve assembly to damp the moving; and
restricting the flow of hydraulic fluid through the valve assembly to limit the moving.

2. The method of claim 1, including actuating a release mechanism to stop the restricting and permit the moving.

3. The method of claim 1, wherein the restricting comprises preventing flow of the hydraulic fluid through the valve assembly.

4. The method of claim 1, wherein, during the restricting, the piston assembly is flexible in retraction and rigid in extension.

5. The method of claim 1, wherein, during the restricting, the piston assembly is rigid in extension and flexible in extension.

6. The method of claim 1, wherein, during the restricting, the piston assembly is flexible in retraction and flexible in extension.

7. The method of claim 1, wherein, during the restricting, the piston assembly is rigid in extension and rigid in extension.

8. The method of claim 1, wherein a first end of the piston assembly is attached to a first vehicle component and an opposing, second end of the piston assembly is attached to a second vehicle component, the piston assembly damping movement of the first vehicle component relative to the second vehicle component during the communicating.

9. The method of claim 1, wherein the piston assembly is not biased toward the extended position or the retracted position.

10. A method for operating a lockable damper, comprising:
moving a piston assembly between a retracted position and an extended position relative to a tube;
biasing the piston assembly toward the extended position using, exclusively, at least one mechanical spring;
communicating a flow of hydraulic fluid through a valve assembly to damp the moving; and
restricting the flow of hydraulic fluid through the valve assembly to limit the moving.

11. The method of claim 10, including actuating a release mechanism to stop the restricting and reinitiate the moving.

12. The method of claim 10, wherein the restricting comprises preventing flow of the hydraulic fluid through the valve assembly.

13. The method of claim 10, including rotating the piston assembly relative to a non-vertical path during the moving.

14. A damper, comprising:
a piston assembly moveable between an extended position and a retracted position;
a tube containing a supply of hydraulic fluid, the piston assembly unbiased toward either the extended position or the retracted position;
a valve assembly disposed within the tube, the valve assembly coupled in movement together with the piston assembly; and
a release mechanism operatively linked to the valve assembly to move a portion of the valve assembly from a first position that restricts a flow of the hydraulic fluid through the valve assembly to a second position that provides a greater flow through the valve assembly.

15. The damper of claim 14, wherein the first position blocks the flow of the hydraulic fluid through the valve assembly.

16. The damper of claim 14, wherein the piston assembly is self-centering within the tube.

17. The damper of claim 14, including a cavity at an end of the tube opposite the piston assembly to permit the piston assembly to retract when the valve assembly is in the first position.

18. The damper of claim 14, wherein the release mechanism is biased toward the first position and away from the second position.

19. The damper of claim 17, wherein the release mechanism assembly is biased toward the second position and away from the first position.
